(19) United States
(12) Patent Application Publication
(10) Pub. No.: US 2025/0204717 A1
(43) Pub. Date: Jun. 26, 2025

(54) LARGE-CAPACITY ELECTRICALLY HEATED COFFEE URN

(71) Applicant: Foshan Shunde Surewin Electric Appliance Industries Co., Ltd, Foshan (CN)

(72) Inventor: Lifei LIU, Dalian (CN)

(73) Assignee: Foshan Shunde Surewin Electric Appliance Industries Co., Ltd, Foshan (CN)

(21) Appl. No.: 18/899,171

(22) Filed: Sep. 27, 2024

(30) Foreign Application Priority Data
Dec. 26, 2023 (CN) 2023235780840

(51) Int. Cl. A47J 31/30; A47J 31/46

(52) U.S. Cl. CPC A47J 31/306; A47J 31/46

(57) ABSTRACT

The present invention provides a large-capacity electrically heated coffee urn, including an urn body having a water storage cavity, a faucet, and a heating device, where the faucet is arranged on an outer wall of the urn body and is in communication with the water storage cavity, a spray base, a percolating tube, a coffee basket, and a brew pad are arranged in the water storage cavity, a water passing structure in communication with the water storage cavity is formed in the spray base, the percolating tube is mounted on the spray base and is in communication with an interior of the spray base, the coffee basket and the brew pad are mounted on the percolating tube, the coffee basket is located below the brew pad.

### CROSS-REFERENCE TO RELATED APPLICATIONS

The application claims priority to Chinese patent application No. 2023235780840, filed on Dec. 26, 2023, the entire contents of which are incorporated herein by reference.

### TECHNICAL FIELD

The present invention relates to the technical field of coffee urns, and in particular, to a large-capacity electrically heated coffee urn.

### BACKGROUND

At present, a coffee urn on the market has an advantage of having a large-capacity water storage cavity, being capable of storing and heating a large amount of coffee liquid, and providing a user with a large amount of coffee for enjoyment. The coffee urn is commonly founded in places such as a restaurant, a food shop and a production workshop. However, the coffee liquid stored in this manner is low in coffee quality and poor in taste, and is not suitable for use in some advanced restaurants and hotels.

Therefore, it is necessary to make further improvements thereto.

### SUMMARY

To resolve the foregoing problem, the present invention provides a high-capacity electrically heated coffee urn. In addition to a function of boiling water, the coffee urn also has the function of extracting drinks such as tea leaves and coffee.

The present invention provides a large-capacity electrically heated coffee urn, including an urn body having a water storage cavity, a faucet, and a heating device, wherein the faucet is arranged on an outer wall of the urn body and is in communication with the water storage cavity, a spray base, a percolating tube, a coffee basket, and a brew pad are arranged in the water storage cavity, a water passing structure in communication with the water storage cavity is arranged on the spray base, the percolating tube is mounted on the spray base and is in communication with an interior of the spray base, the coffee basket and the brew pad are mounted on the percolating tube, the coffee basket is located below the brew pad, the brew pad is used for receiving liquid output from a water outlet end of the percolating tube, the spray base is arranged at an inner bottom of the water storage cavity, and the heating device is arranged at an outer bottom of the water storage cavity and corresponds to a position of the spray base.

In one or more embodiments, a top of the urn body is provided with an urn cover used for opening the water storage cavity, and after the urn cover is connected to the urn body, the spray base is tightly pressed on the inner bottom of the water storage cavity by pressing the percolating tube.

In one or more embodiments, the water outlet end is formed at an opening in a top of the percolating tube, the brew pad is arranged at a position close to the top of the percolating tube, and a plurality of water falling holes are uniformly distributed on a bottom wall of the brew pad.

In one or more embodiments, the coffee basket is a filter shell with an upper opening, a filter cavity is formed inside the filter shell, and a plurality of filtrate holes are distributed at a bottom of the filter shell.

In one or more embodiments, the spray base is provided with a lower opening, a mounting hole for inserting a bottom end of the percolating tube is formed in a middle position of the spray base, and a limiting convex portion abutting against the spray base is arranged at the bottom end of the percolating tube.

In one or more embodiments, the water passing structure includes one or more water passing holes, and the water passing hole penetrates through a shell wall of the spray base.

Compared with the prior art, this solution has the following beneficial effects: the coffee urn has a large-capacity water storage cavity, daily use can be boiled, heated and insulated by pouring clear water, and a large amount of hot water supply is provided for the user; and a large amount of high-quality coffee liquid or tea water can be obtained in an extraction manner by putting coffee powder, tea leaves or the like into the coffee basket.

### BRIEF DESCRIPTION OF THE DRAWINGS

FIG. 1 is a section view of a coffee urn according to an embodiment of the present invention; and

FIG. 2 is a schematic structural diagram of a spray base, a percolating tube, a coffee basket, and a brew pad according to an embodiment of the present invention.

### DETAILED DESCRIPTION OF THE EMBODIMENTS

In order to deepen the understanding of the present invention, the present invention will be further described in detail below with reference to the embodiments and the accompanying drawings. The embodiments are only used for explaining the present invention, and do not constitute any limitation on the protection scope of the present invention.

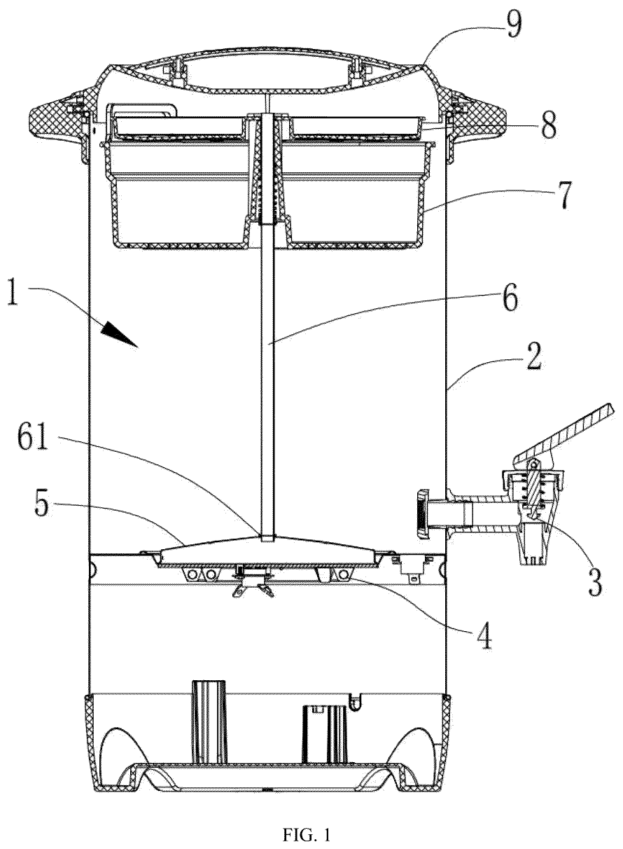

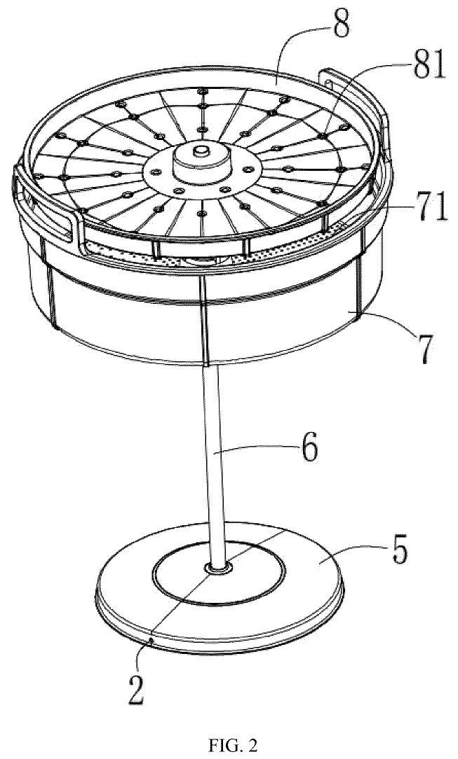

Referring to FIG. 1 and FIG. 2, the present invention provides a large-capacity electrically heated coffee urn, including an urn body 2 having a water storage cavity 1, a faucet 3, and a heating device 4, wherein the faucet 3 is arranged on an outer wall of the urn body 2 and is in communication with the water storage cavity 1, a spray base 5, a percolating tube 6, a coffee basket 7, and a brew pad 8 are arranged in the water storage cavity 1, a water passing structure in communication with the water storage cavity 1 is formed in the spray base 5, the percolating tube 6 is mounted on the spray base 5 and is in communication with an interior of the spray base, the coffee basket 7 and the brew pad 8 are mounted on the percolating tube 6, the coffee basket 7 is located below the brew pad 8, the brew pad 8 is used for receiving liquid output from a water outlet end of the percolating tube 6, the spray base 5 is arranged at an inner bottom of the water storage cavity 1, and the heating device 4 is arranged at an outer bottom of the water storage cavity and corresponds to a position of the spray base 5. When in use, a user pours clear water into the water storage cavity and puts an appropriate amount of coffee powder or tea leaves into the coffee basket. When the heating device works for heating, water located inside the spray base rapidly boils and flows upwards along the percolating tube, and boiling hot water flows out from an output end of an upper water pipe. The hot water firstly enters the brew pad, and then drips into the coffee basket below through the brew pad to extract coffee powder or tea leaves. The extracted coffee liquid or tea water falls into the water storage cavity to be mixed with water in the water storage cavity, and after being heated for a period of time, the clear water in the water storage cavity can be completely changed into coffee liquid or tea water for the user to drink.

The brew pad is arranged to cool the boiling hot water to a certain extent, so as to prevent the hot water from directly falling into the coffee basket to excessively extract coffee powder or tea leaves.

Atop of the urn body 2 is provided with an urn cover 9 used for opening the water storage cavity, and after the urn cover is connected to the urn body, the spray base 5 is tightly pressed on the inner bottom of the water storage cavity 1 by pressing the percolating tube 6, so that the spray base is prevented from being jacked up due to boiling of hot water.

The water outlet end is formed at an opening in a top of the percolating tube 6, the brew pad 8 is arranged at a position close to the top of the percolating tube 6, and a plurality of water falling holes 81 are uniformly distributed on a bottom wall of the brew pad 8, so as to ensure that hot water can be uniformly dripped into the coffee basket below to extract coffee powder or tea leaves.

The coffee basket 7 is a filter shell with an upper opening, a filter cavity is formed inside the filter shell, and a plurality of filtrate holes 71 are distributed at a bottom of the filter shell, so as to ensure that hot water dripped into the coffee basket is fully in contact with the coffee powder to extract coffee liquid, and can only drip from the bottom, so that hot water is prevented from flowing around.

The spray base 5 is provided with a lower opening, a mounting hole for inserting a bottom end of the percolating tube 6 is formed in a middle position of the spray base, and a limiting convex portion 61 abutting against the spray base is arranged at the bottom end of the percolating tube. The spray base and the percolating tube can be disassembled and assembled by using this structure. The water passing structure includes one or more water passing holes 51, and the water passing hole penetrates through a shell wall of the spray base. In this solution, two water passing holes are provided, and the two water passing holes are oppositely arranged on two side walls of the spray base.

The foregoing descriptions are merely preferred embodiments of the present invention, and the protection scope of the present invention is not limited to the above embodiments, and any equivalent modifications or changes made by a person of ordinary skill in the art according to the content disclosed in the present invention shall fall within the scope of protection as defined in the claims.

What is claimed is:

1. A large-capacity electrically heated coffee urn, comprising an urn body (2) having a water storage cavity (1), a faucet (3), and a heating device (4), wherein the faucet (3) is arranged on an outer wall of the urn body (2) and is in communication with the water storage cavity (1), a spray base (5), a percolating tube (6), a coffee basket (7), and a brew pad (8) are arranged in the water storage cavity (1), a water passing structure in communication with the water storage cavity (1) is formed in the spray base (5), the percolating tube (6) is mounted on the spray base (5) and is in communication with an interior of the spray base, the coffee basket (7) and the brew pad (8) are mounted on the percolating tube (6), the coffee basket (7) is located below the brew pad (8), the brew pad (8) is used for receiving liquid output from a water outlet end of the percolating tube (6), the spray base (5) is arranged at an inner bottom of the water storage cavity (1), and the heating device (4) is arranged at an outer bottom of the water storage cavity and corresponds to a position of the spray base (5).

2. The large-capacity electrically heated coffee urn according to claim 1, wherein a top of the urn body (2) is provided with an urn cover (9) used for opening the water storage cavity, and after the urn cover is connected to the urn body, the spray base (5) is tightly pressed on the inner bottom of the water storage cavity (1) by pressing the percolating tube (6).

3. The large-capacity electrically heated coffee urn according to claim 1, wherein the water outlet end is formed at an opening in a top of the percolating tube (6), the brew pad (8) is arranged at a position close to the top of the percolating tube (6), and a plurality of water falling holes (81) are uniformly distributed on a bottom wall of the brew pad (8).

4. The large-capacity electrically heated coffee urn according to claim 3, wherein the coffee basket (7) is a filter shell with an upper opening, a filter cavity is formed inside the filter shell, and a plurality of filtrate holes (71) are distributed at a bottom of the filter shell.

5. The large-capacity electrically heated coffee urn according to claim 1, wherein the spray base (5) is provided with a lower opening, a mounting hole for inserting a bottom end of the percolating tube (6) is formed in a middle position of the spray base, and a limiting convex portion (61) abutting against the spray base is arranged at the bottom end of the percolating tube.

6. The large-capacity electrically heated coffee urn according to claim 1, wherein the water passing structure comprises one or more water passing holes (51), and the water passing hole penetrates through a shell wall of the spray base.
